(19) United States
(12) Patent Application Publication
(10) Pub. No.: US 2002/0069145 A1
(43) Pub. Date: Jun. 6, 2002

(54) Software system providing time card reporting using a calendar system

(76) Inventors: Luis Collado, Chicago, IL (US); Jose Luis De LaFuente, Chicago, IL (US); Ben Tweel, Chicago, IL (US); Stephen Ward, Chicago, IL (US); Ben Gottlieb, Chicago, IL (US); Jim Austin, Chicago, IL (US)

Correspondence Address: Michael L. Kenaga, Esq., Piper Marbury Rudnick & Wolfe, P.O. Box 64807, Chicago, IL, 60664-0807, US

(21) Appl. No.: 09/730,234

(22) Filed: Dec. 5, 2000

(51) Int. Cl. G06F 17/60

(52) U.S. Cl. 705/32

(57) ABSTRACT

A software system is provided for a conventional appointment calendar system having a calendar database for storing appointment information for plural appointment entries. The software system utilizes the date, time duration and descriptive appointment information for each appointment entry as the starting point for generating timecard records for export to an external accounting system. The software system is provided with an administrative interface for entering project information for each of a plurality of projects, a timecard user interface for creating timecard records by associating a selected calendar appointment entry with a selected one of the predefined projects, and a data export module for exporting the timecard records to the external accounting system.

### FIELD OF THE INVENTION

The present invention relates to a software system which adds billing time and expense tracking functionality to a conventional calendar system. In particular, the software system of the present invention relates to a software add on (plug-in) to a conventional calendar system which provides a user interface for entering time card information billing time and expense information for each of plural predefined projects. More particularly, the software system reduces the amount of information a user is required to enter to generate time card records by utilizing the appointment information data already entered into the calendar.

### BACKGROUND

Personal information management (PIM) software such as Microsoft Outlook include a calendar providing a user with a convenient way to track and schedule appointments. Unfortunately, conventional PIM software does not provide a way to utilize the information gathered by the calendar for other purposes such as tracking a user's billing time and expenses. Consequently, users are forced re-enter much of the data already contained in the calendar into a separate accounting software package to track this information. Moreover, the data entered into the PIM software is not accessible to the user for generating reports and the like.

Conventional billing time tracking/accounting software utilizes so-called dumb interfaces which enable a user to bill time and expenses to any project defined in the system. One drawback associated with dumb interfaces is their inability to prevent users from billing time and expense data to the wrong project. A closely related drawback of conventional dumb interfaces relates to the time required to scroll through the list of projects to determine the appropriate billing code. Notably, conventional interfaces display a scrollable list of all the projects defined in the system. However, the list of projects on which a given user is actively working is significantly smaller than the overall list of projects defined in the system. Consequently, the user is required to scroll through many irrelevant projects to locate a desired project which is time consuming and increases the likelihood that the user will select the wrong project.

In view of the above-described aspects of the prior art, a first objective of the present invention is to provide a software system for a conventional calendar system which mines the appointment data in the calendar system to provide time and description information for generating timecard entries and exporting the same to a conventional accounting system.

Another objective of the present invention is to provide a smart user interface which only accepts timecard data for projects assigned to a given user.

Yet another object of the present invention is to provide a smart user interface which only displays those projects for which the user may enter timecard data, wherein the list of projects is customized for each user.

Yet another object of the present invention is to provide a system database for storing project information and timecard information for various users.

These and other objects of the present invention are discussed or will be apparent from the detailed description of the invention.

### SUMMARY OF THE INVENTION

In accordance with a first aspect of the present invention, a software system is provided for a conventional appointment calendar system having a calendar database for storing appointment information for plural appointment entries. The software system utilizes the data, time duration and descriptive appointment information for each appointment entry as the starting point for generating timecard records for export to an external accounting system.

The software system is provided with an administrative interface for entering project and company for each of a plurality of projects, a timecard user interface for creating timecard records by associating a selected calendar appointment entry with a selected one of the predefined projects, and a data export module for exporting the timecard records to the external accounting system.

A second aspect of the invention corresponds to a software system providing seamless integration between an executive information system and a plurality of calendar systems. The executive information system includes an executive information system database, and an administrative interface. The administrative interface is used to enter project and company information for each of a plurality of projects into the executive information system database, and to allocate at least one user each of the projects. The executive information system further includes a system report generator for accessing the executive information system database and generating user reports for a selected user as well as global reports for a plurality users on at least one of a calendar day basis and a project basis.

Each calendar system stores appointment information in a calendar database, and includes a calendar user interface for displaying the appointment information and the project information for a given user. The calendar user interface of the present invention enables a user to generate timecard records by associating the project information for a selected project with the appointment information for a selected appointment. The calendar user interface only permitting the given user to generate timecard records using the displayed projects, and storing the timecard records in the calendar database.

The software system further includes at least one data transfer module for transferring timecard records from each of the plurality of calendar databases to the executive information system database, and a data export module for exporting timecard records from the executive information system database to an external accounting system.

### BRIEF DESCRIPTION OF THE DRAWINGS

The above mentioned and other features of this invention and the manner of obtaining them will be apparent, and the invention itself will be best understood, by reference to the following detailed description of the preferred embodiments in conjunction with the drawings, in which:

FIGS. 1A-1C are block diagrams of the timecard system of the present invention;

FIGS. 2A and 2B show sample data layouts for storing project and supplemental information;

FIG. 3 is a flow diagram for defining a project using the administrative interface of the present invention;

FIG. 3A is a sample report generated using the timecard system of the present invention;

FIG. 3B is a flow diagram for creating a timecard record;

FIG. 4A is an sample screen print of an administrative interface of the present invention;

FIG. 4B is an sample screen print of a timecard interface of the present invention;

FIG. 4C is an sample screen print of a conventional calendar system;

FIG. 5A is a block diagram of a network of calendar systems which communicate with an executive information system according to the present invention;

FIG. 5B is a block diagram of an executive information system according to the present invention;

FIG. 5C is a block diagram of a calendar system according to the present invention;

FIG. 6A is a sample project detail report showing the total project budget as well as the number of hours billed to the project by each of the users;

FIG. 6B is a sample project summary report showing the project budget and the total amount billed to the project; 6B)

FIG. 6C is a sample individual summary report for a selected user;

FIG. 7 is a flow diagram providing an overview of the process for defining the company and resource data and allocating resources using the administrative interface of the present invention;

FIG. 8 is a detailed flow diagram for defining the resources of the service provider company using the administrative interface of the present invention;

FIG. 9 is a flow diagram for defining employees of the service provide company;

FIG. 10 is a flow diagram for defining a project using the administrative interface of the present invention;

FIG. 11A is a flowchart showing the data export process;

FIG. 11B is a flow diagram showing optional steps for defining various accounting information used by the accounting system to import the data; and

FIG. 11C is a sample data record layout for an invoice record and a payroll record.

### DETAILED DESCRIPTION OF THE PREFERRED EMBODIMENTS

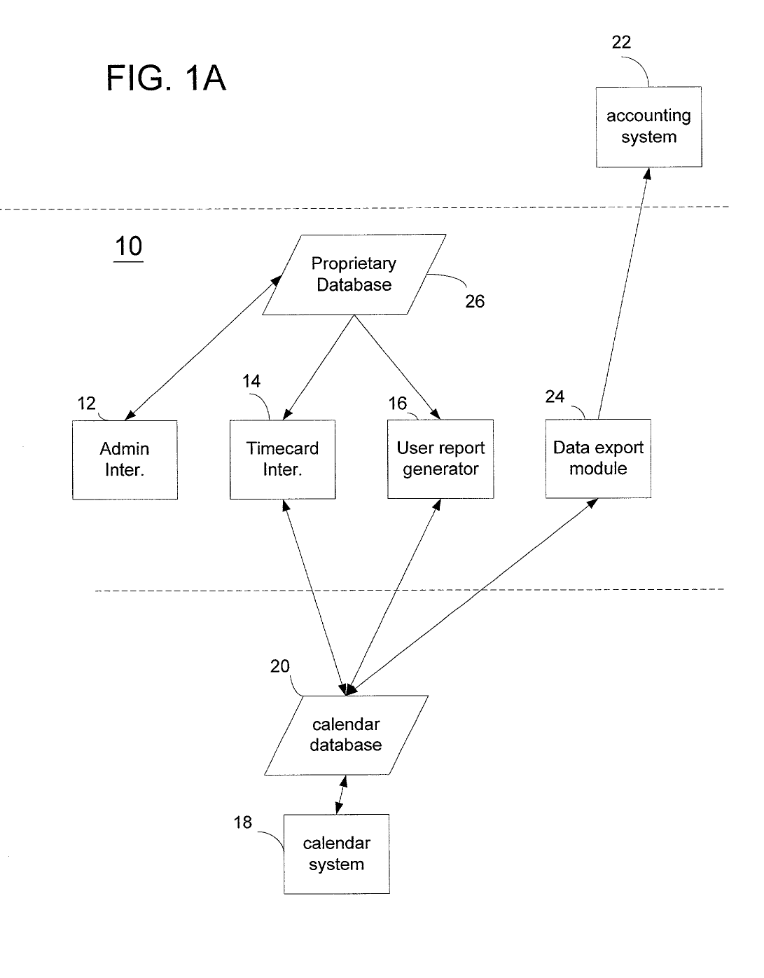

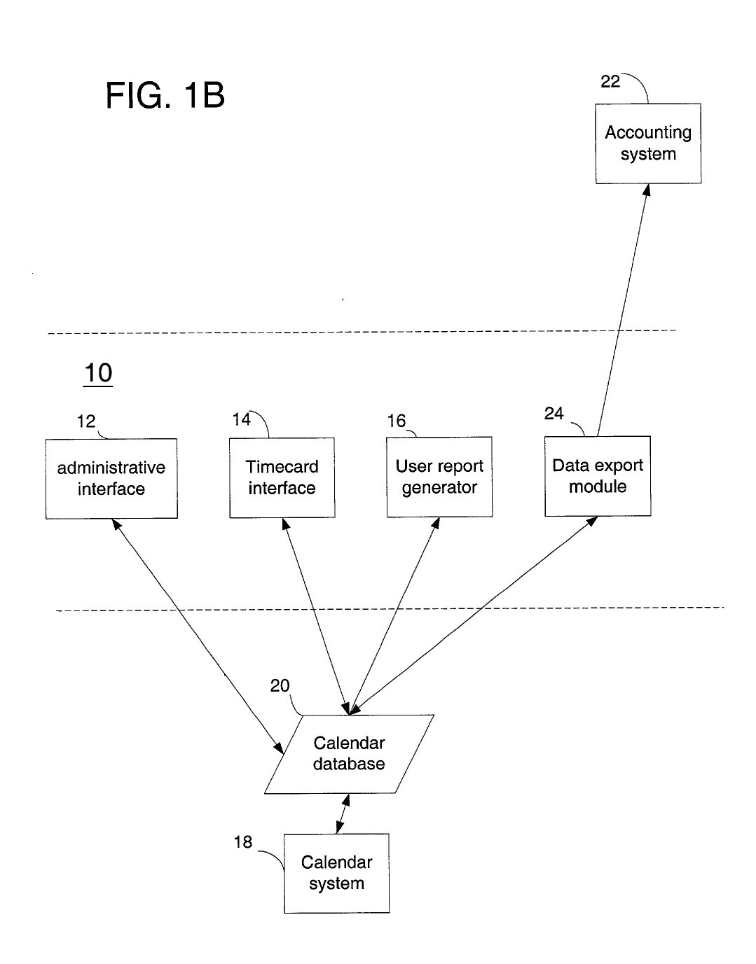

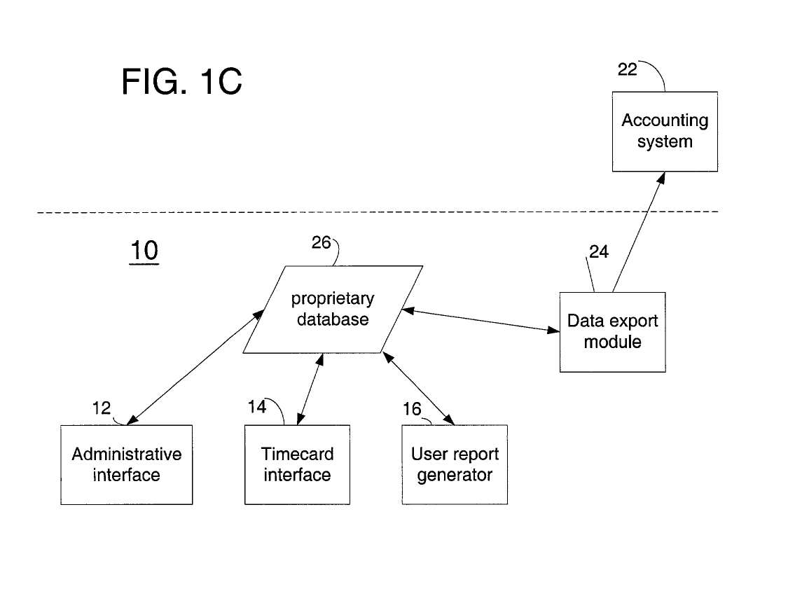

The first aspect of the present invention relates to a software system module for a conventional calendar system such as Microsoft Outlook, and will be explained with reference to FIG. 1A. The software system of the present invention is generally designated 10, and includes an administrative interface 12, a calendar user interface 14, and a user report generator 16. The software system 10 communicates with a conventional third-party calendar system 18, such as Microsoft Outlook®, having a calendar database 20.

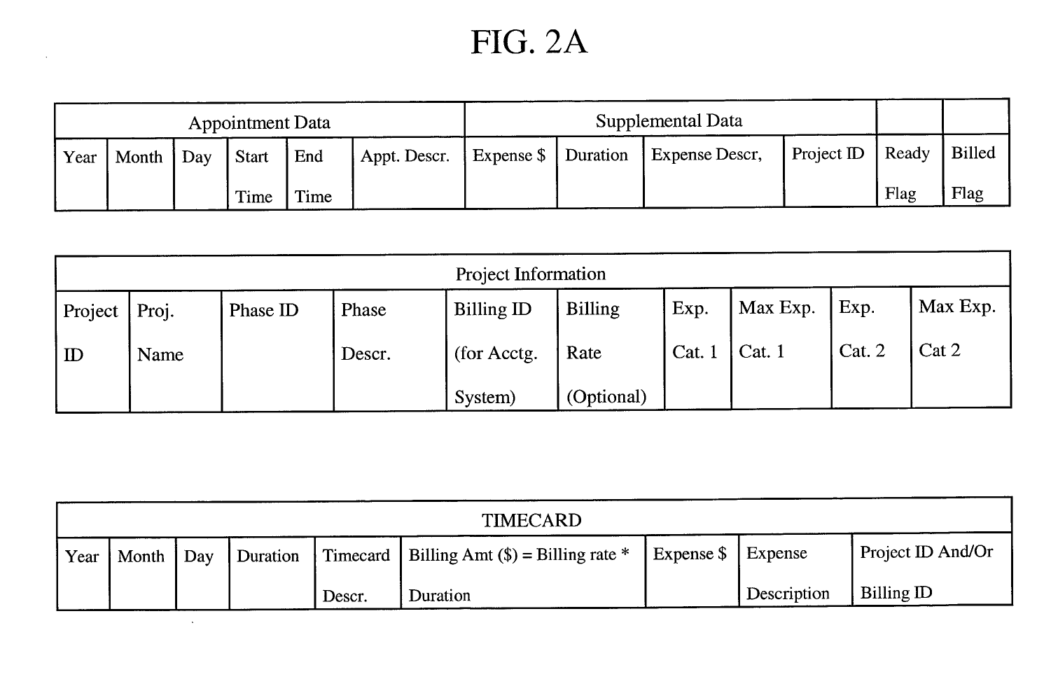

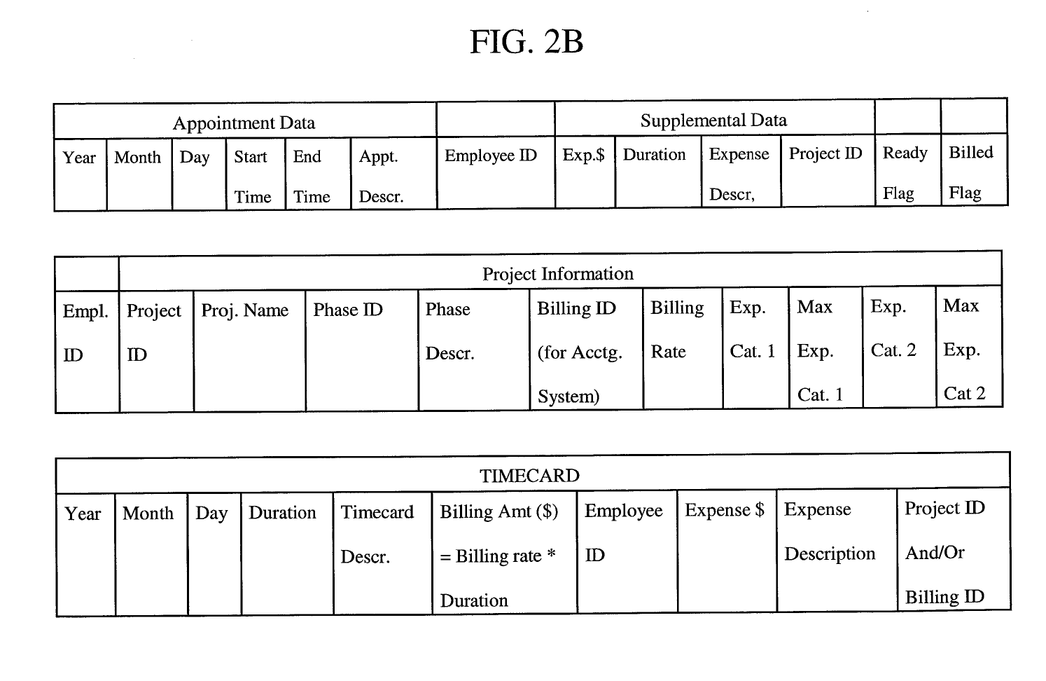

Conventional calendar systems 18 enable a user to enters appointment data specifying the date, and start/end time for each appointment entry, as well as descriptive information regarding the appointment. The appointment data and descriptive data are stored in the conventional calendar database 20. See, FIGS. 1A, and 2A.

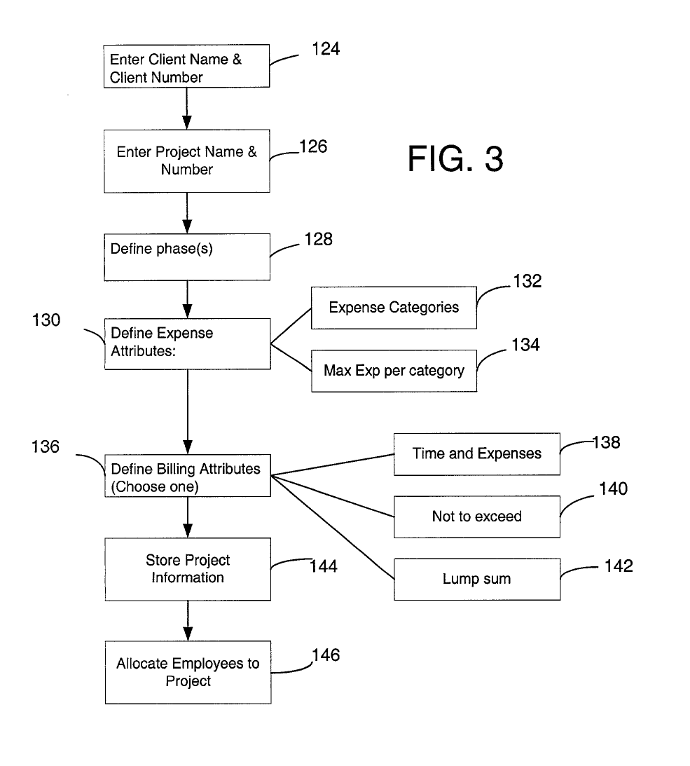

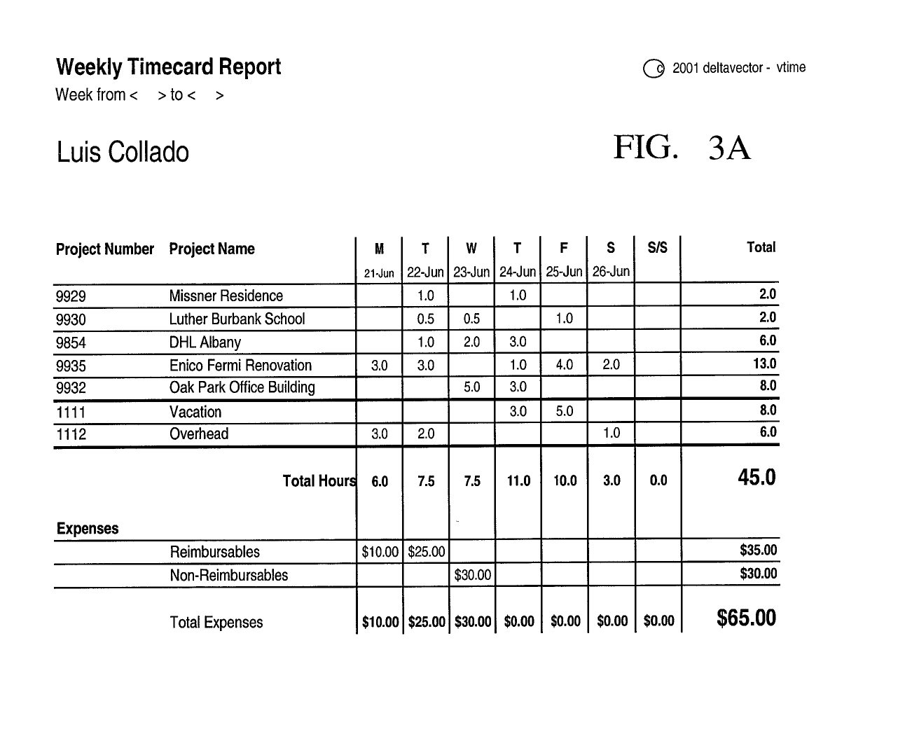

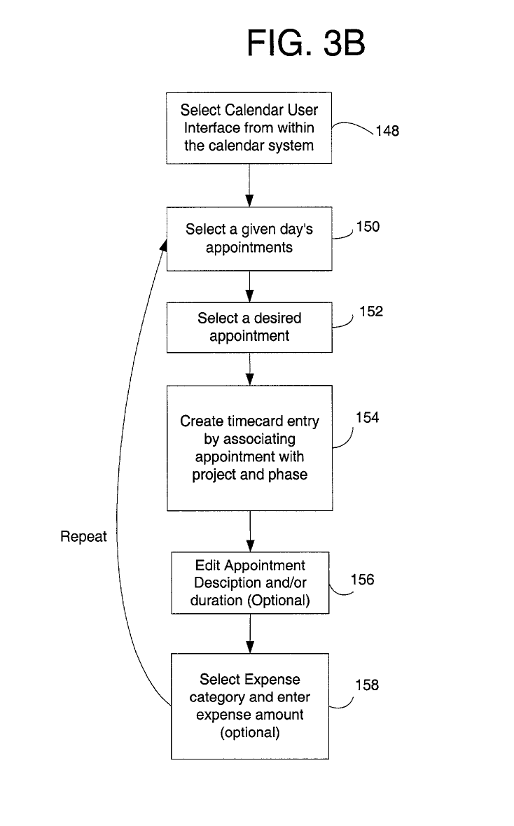

The software system 10 provides added functionality to the calendar system 18, enabling a user to utilize (mine) the appointment data to create timecard records which may, for example, be exported to a conventional accounting system 22 by a data export module 24 or used by the user report generator 16 to generate timecard reports. See, e.g. FIG. 3A. Each calendar appointment is used as the basis for a distinct timecard record, with the duration and description of each appointment entry being displayed in the calendar user interface 14. Consequently, generation of a timecard record merely requires that the user assign (associate) a project identifier (project ID) from the provided list of valid project/phase identifier with a given appointment entry.

Thus, the software system 10 is not intended to eliminate the use of conventional accounting system 22, but rather is intended to provide a convenient, smart user interface 14 for entering and managing timecard data for a plurality of projects. Importantly, the software system 10 simplifies the task of generating timecard records by utilizing the appointment duration and description information already contained in the calendar database.

It should be appreciated that each project may optionally include any number of phases. Thus, a timecard record can be generated for a particular phase of a given project by associating both a project and a phase with a selected appointment entry. Moreover, the user report generator 16 enables the generation of reports for each phase of a project.

FIG. 3 is a flow diagram of the process for defining a project.

The process begins by entering the client name and billing ID (step 124), and the project name and project ID (step 126). Notably, the accounting system 22 utilizes the Billing ID and/or the project ID in processing the timecard data.

Next, the user is prompted to define the phases for the project (step 128), and to select the expense attributes (130) for each project are defined. The expense attributes include a list of expense categories 132 such as parking, tolls, taxi, airfare. Optionally, the expense attributes may include a maximum expense 134 for each expense category. In step 136, the billing attributes are selected from a list of attributes including time and expense 138, not to exceed, 140, and lump sum 142. Subsequently, the project information is stored (step 144), and employees are allocated to the project (step 146).

The time and expense billing attribute identifies that the client will be billed for actual time and expenses expended during each phase of a project, and does not include a maximum amount of time. Corresponding, the not to exceed attribute identifies that the client will be billed for actual time and expenses up to (not to exceed) a maximum amount. Finally, the lump sum attribute identifies that the client will be billed a lump sum regardless of the actual time and expenses.

The administrative interface 12 is used to define the projects which the calendar user interface 14 uses to generate timecard records. A project definition may for example include a project name and/or project code. In the event that a common project definition file is shared by plural users, the project definition may optionally include a name/user identifier of users authorized to bill to a given project. Optionally, the project definition may include a client and matter identifier used to export the timecard data into the conventional accounting system, and phase information specifying the number of phases for a given project. Moreover, the project information may optionally include an hourly rate for each of plural hourly billing categories, wherein the administrative interface 12 prompts an administrator to assign a selected hourly billing category to each user allocated to a given project.

The calendar user interface 14 enables the user to generate timecard records by associating a project name with an appointment entry. The process for creating a timecard entry will be explained with reference to FIG. 3B.

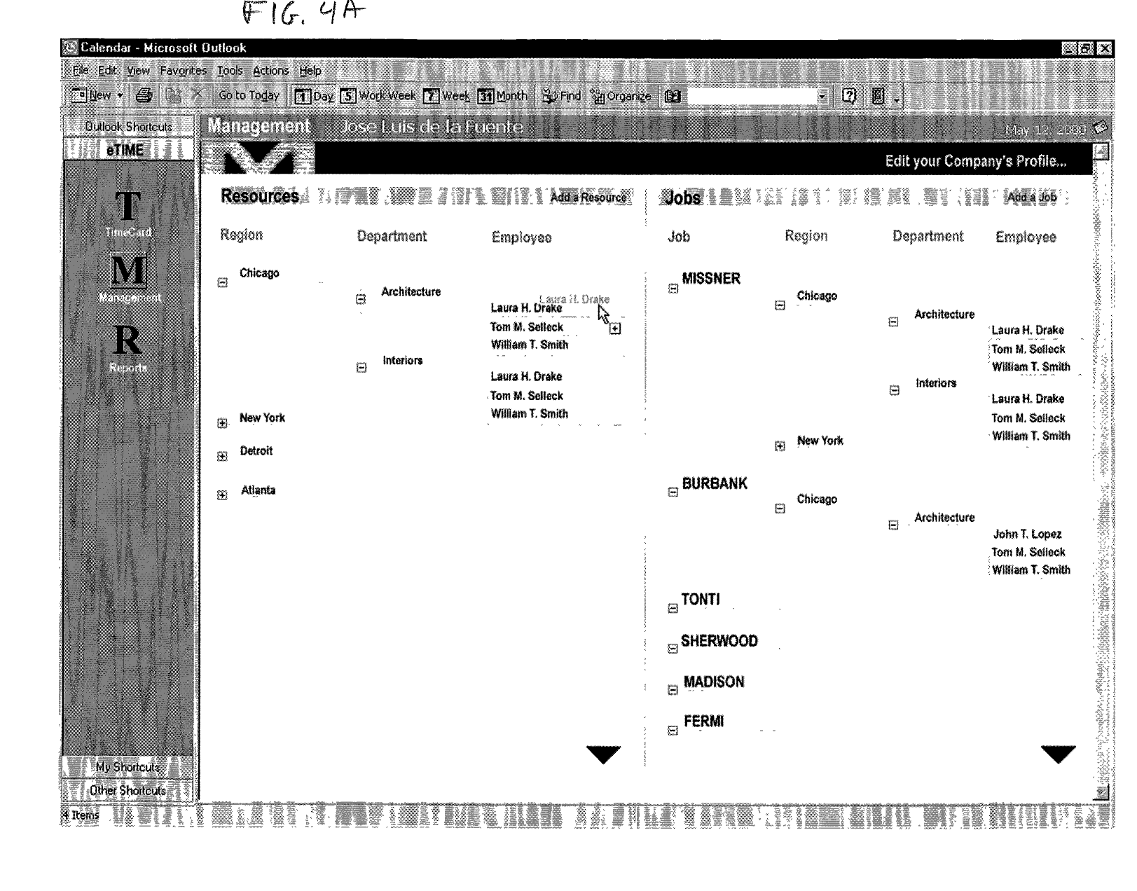

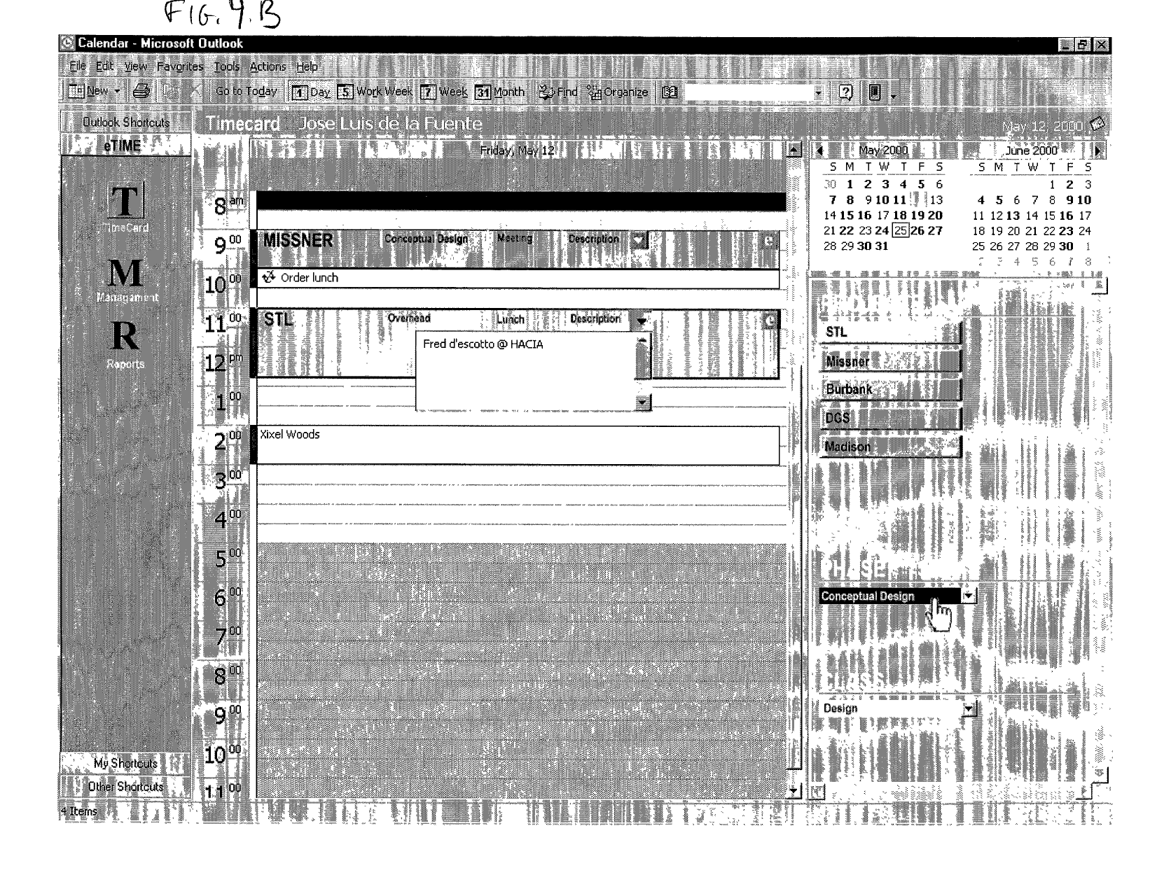

First the user selects the calendar user interface 14 (FIG. 4B) from within the calendar system 18 (FIG. 4C) by selecting an icon or tab 28 (step 148), and selects a desired day (step 150) and appointment (step 152). Next, the user generates a timecard record by associating the appointment entry with a project (and phase) by selecting from a menu of authorized projects and a menu of phases for the selected project (step 154). As described above, the appointment description information is utilized as the timecard description and the appointment start and end times is used to calculate a timecard duration which is used as the timecard duration, thereby streamlining the process for generating timecard records. See, e.g. FIG. 4B. If necessary, the user may edit the timecard description information as well as the timecard duration information through the calendar user interface 14 (step 156).

In addition to tracking hours for each project (or phase of a project) each timecard record may further track expense information. Towards this end, the calendar user interface 14 enables the user to enter expense amount and expense description information (step 158). According to a preferred embodiment, the user is provided with a predefined list of expense categories, and is merely required to enter an expense amount for one or more of the predefined billing categories. The billing categories are defined from within the administrative interface, and may be included in the project information, or may be stored independent of any given project.

According to a preferred embodiment, the user selects a given appointment entry using a pointing device such as a mouse or the like, or using a touch sensitive screen. The use of such pointing devices is well known in the art. Once the desired calendar entry is selected, the calendar user interface 14 displays a list of authorized projects, and the user selects a given project entry again using a pointing device such as a mouse or the like, or using a touch sensitive screen.

As described above, the software system 10 of the present invention generally uses three distinct types of data: appointment data, supplemental data, and project data. See, FIG. 2A. The appointment data reflects data conventionally captured by a calendar system 18 including date, appointment start/end time, and description information for each appointment. The project information includes a project name and/or a project ID, phase name and/or phase ID, and billing rate. Moreover, the project information may further include a billing ID used by the accounting system 22, a maximum expense amount and expense description. The supplemental data includes employee ID, project ID, duration and (optional) expense information.

Also shown in FIG. 2A is a representative timecard record, which includes the date, duration and timecard description, the billing amount, and the project ID and/or billing ID. The timecard record may optionally include the expense amount and expense description.

According to a preferred embodiment, the supplemental data is stored in the calendar database 20 along with the appointment data, and the project information is stored in a proprietary database 26. See, FIG. 1A. It should be noted that the supplemental data identifies correspondence of a particular appointment entry with a particular project, and is stored in the calendar database merely as a matter of convenience. Alternatively, both the supplemental data and project information may be stored in the calendar database 20 (FIG. 1B) or in the proprietary database 26 (FIG. 1C). As shown in FIG. 2, each timecard record consists of date and appointment description and appointment duration information from the calendar data, and project ID, duration and (optional) expense information from the supplemental data.

Depending on where the supplemental and project information data is stored the user report generator 16 may access the calendar database 20 alone, or both the calendar database 20 and the proprietary database 26 to generate reports. According to a preferred embodiment, the user report generator 16 accesses the calendar database 20 for supplemental data and accesses the proprietary database 26 for project information. Moreover, according to the preferred embodiment, the project ID entry in the calendar database 20 is used as an index into the proprietary database 26.

The user report generator 16 may be used to generate reports on a project by project basis showing the total number of hours and total amount of expenses for a given project or phase of a project (FIG. 3). Alternatively, reports may be generated on a calendar basis, showing hours and expenses for any given day or range of days.

As noted above, the administrative interface 12 is used to enter project and company information for defining a plurality of projects. See, FIG. 4A. Typically, the project information includes the project and client name, and an hourly rate for each of several different billing categories. As noted above the project information includes phase definition information defining the number of phases for each project. The project information may further include one or more expense categories. Notably, the calendar user interface 14 will display and receive input only for the predefined expense categories for each project. Optionally, the project information includes a maximum expense for each expense category, wherein the calendar user interface displays a warning message if the entered expense information exceeds the maximum expense.

According to one aspect of the invention, the data export module 24 (FIGS. 1A-1C) is provided for exporting the timecard records to the conventional accounting system 22. If necessary, the data export module 24 may translate the data format of the timecard records from the format in which it is stored in the calendar database (or proprietary database 26) into a format accessible by the accounting system 22.

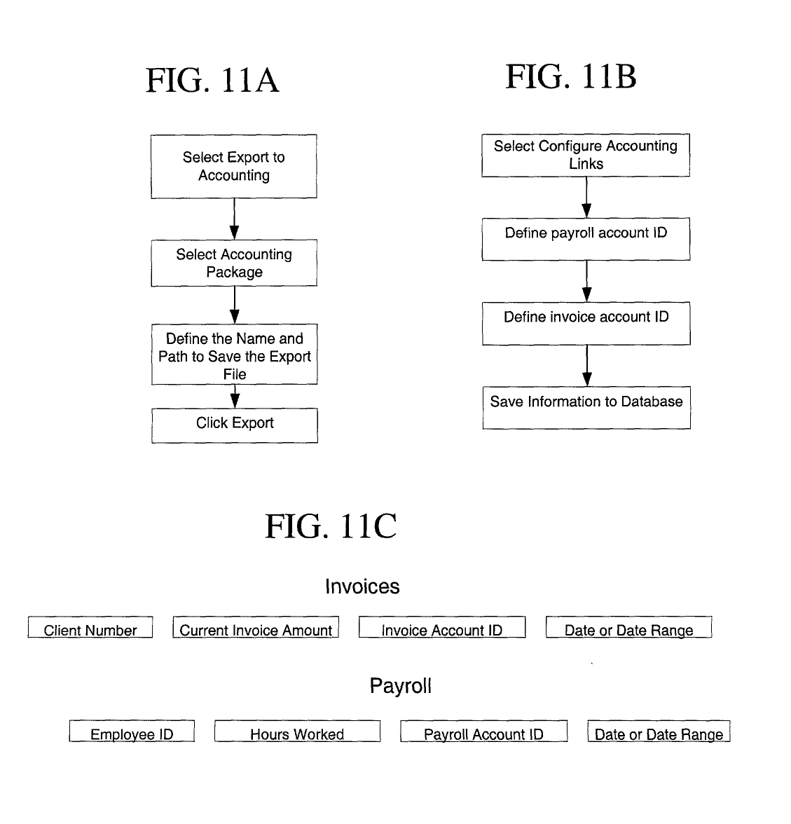

Aspects of the data export module will now be explained with reference to FIGS. 11A-11C, in which FIG. 11A is a flowchart showing the data export process. Data is exported by selecting the export data option, for example, using a icon or the like from within the administrative interface 12 (step 160). The user is then prompted to specify a data export format by selecting an accounting package from a list of accounting packages (step 162), and to define the path and filename of the data file to be exported (step 164). Finally, the user completes the export process by selecting export data (step 166).

Various accounting packages utilize different information to import data. FIG. 11B is a flow diagram showing optional steps for defining various accounting information used by the accounting system to import the data. First, the user selects the configure links option, for example, using a icon or the like from within the administrative interface 12 (step 168). The user is then prompted to specify a payroll ID (step) 170) and/or an invoice account ID (step 172), and stores the data (step 174). FIG. 11C shows a sample data record layout for an invoice record and a payroll record.

Referring once again to FIG. 2A, the supplemental data may optionally include a ready-to-be-submitted flag and a billed flag to facilitate the data export process. The ready-to-be-submitted flag is used to designate that the timecard entry is complete and ready to be exported. Correspondingly, the billed flag is used to designate that the timecard entry has already been exported to either the accounting system 22 or as will be explained below, to the executive information system 34.

In operation, access to the administrative interface 12 (FIG. 4A) or the calendar user interface 14 (FIG. 4B) is gained from within the calendar system 18 (FIG. 4C) by selecting an icon or tab 28.

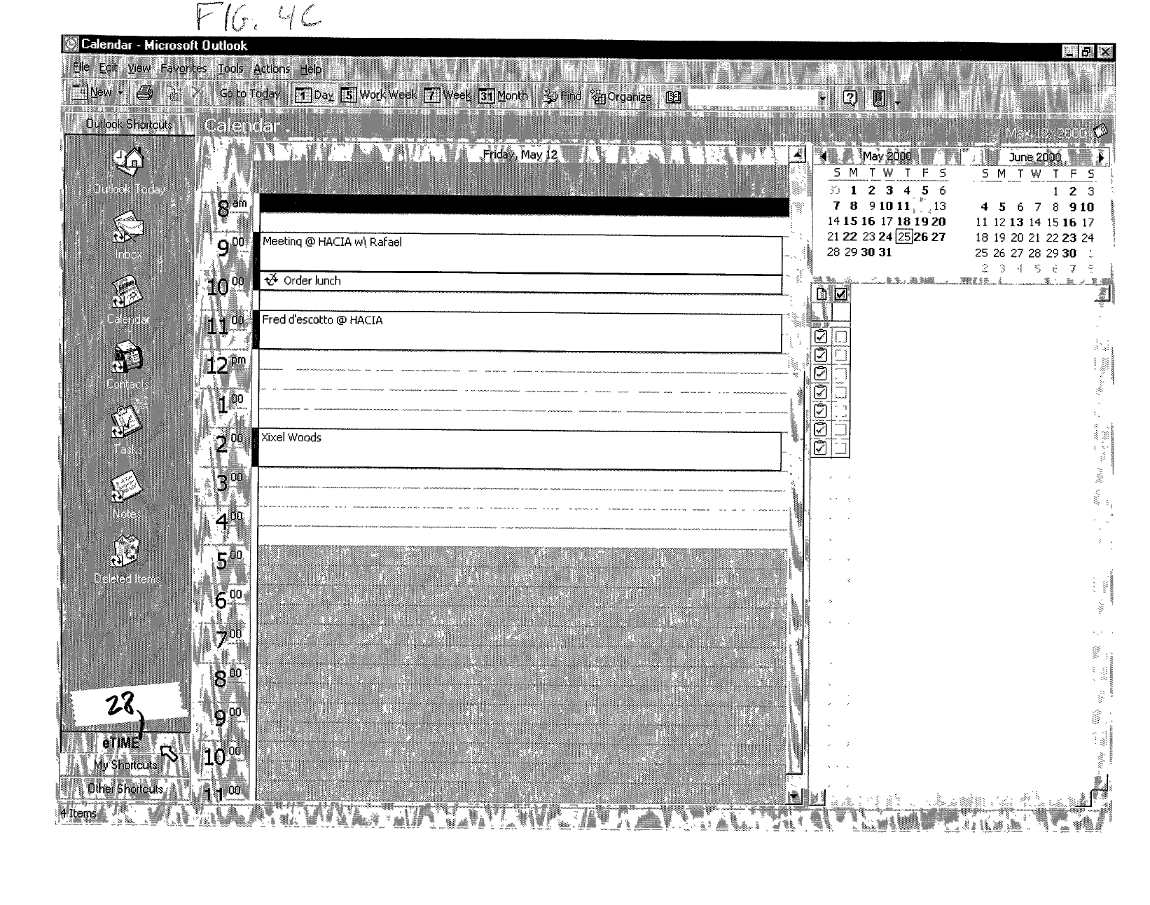

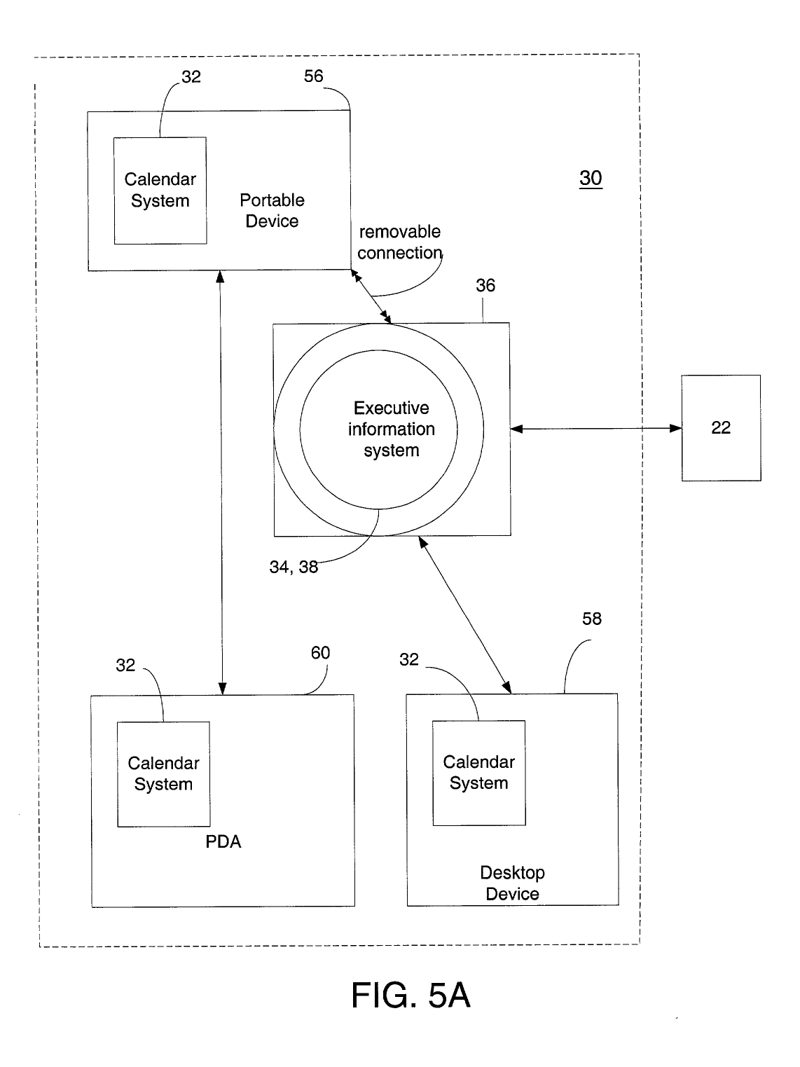

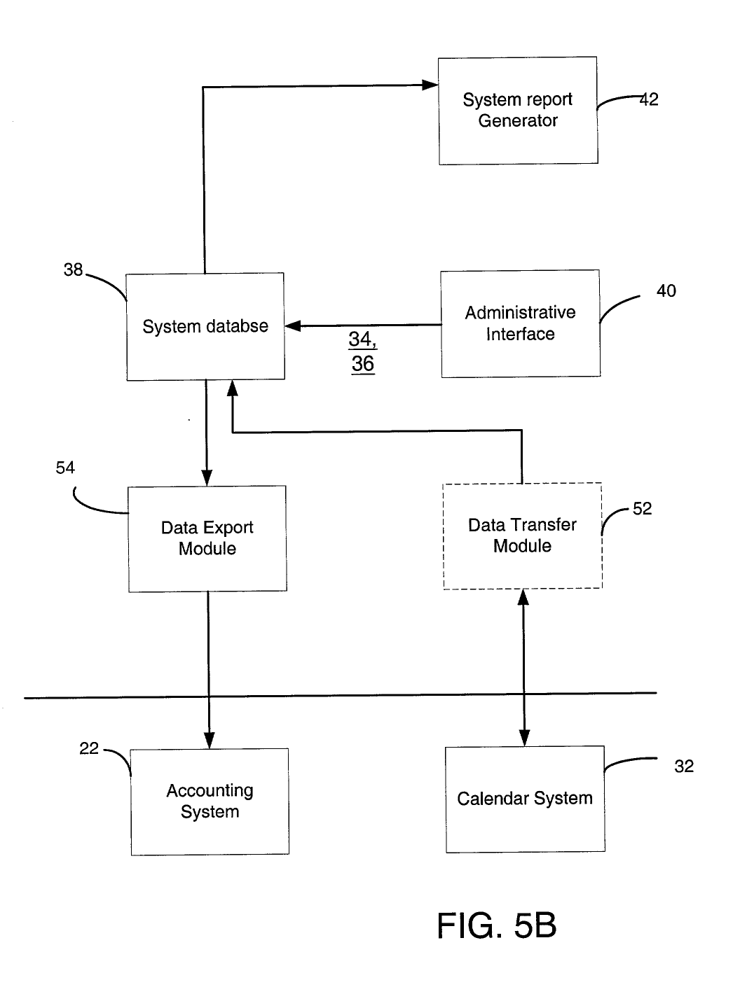

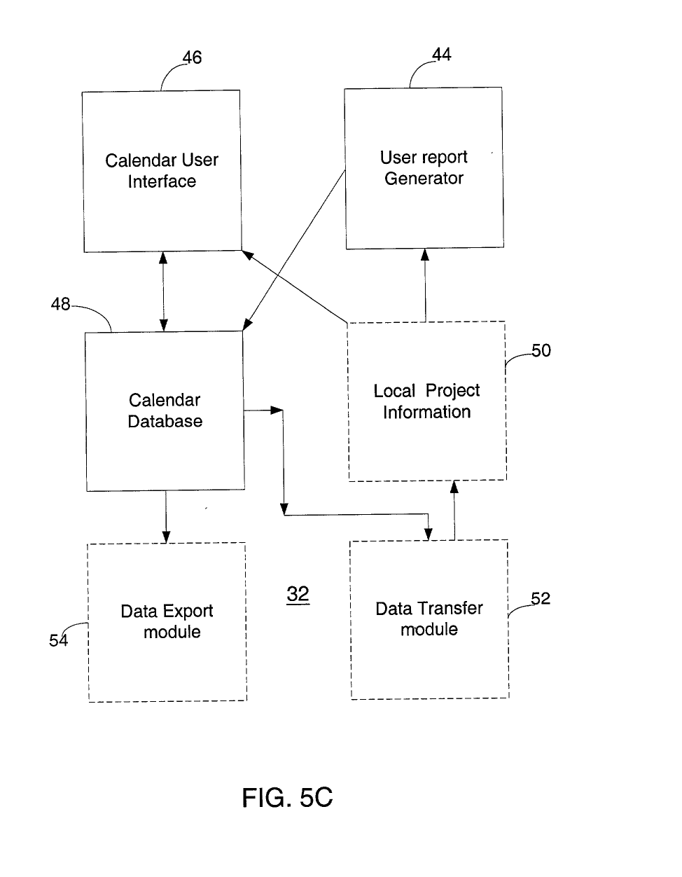

A networked version of the above-described software system will be explained with reference to FIGS. 5A-5C.

FIG. 5A is a block diagram of network system 30 including two or more calendar systems 32 which communicate with an executive information system 34 residing on a server 36. The executive information system 34 includes a system database 38 and an administrative interface 40. See, FIG. 5B.

The administrative interface 40 is used for entering project and company information for each of a plurality of projects into the system database 38, and allocating at least one user to each project.

According to a preferred embodiment, the administrative interface 40 include logic to provide an if a number of projects to which a given user is allocated exceeds a predetermined number. As will be described in further detail below, the executive information system 34 stores time card records received from the various calendar systems 32 in the system database 38.

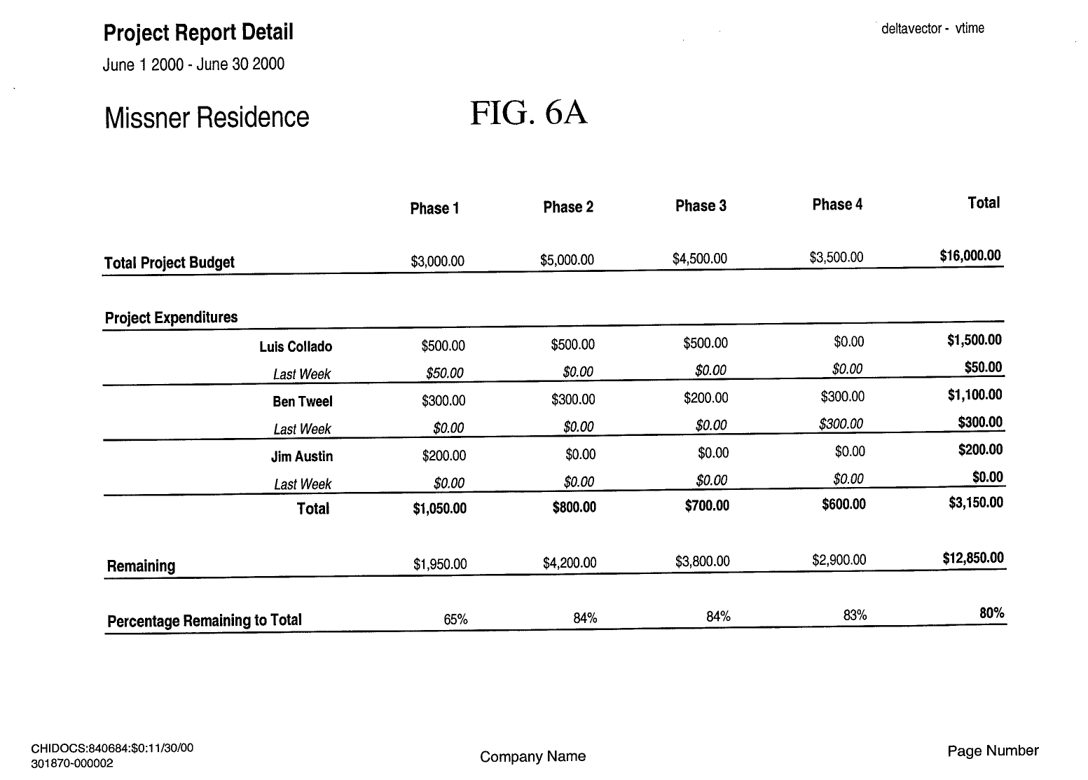

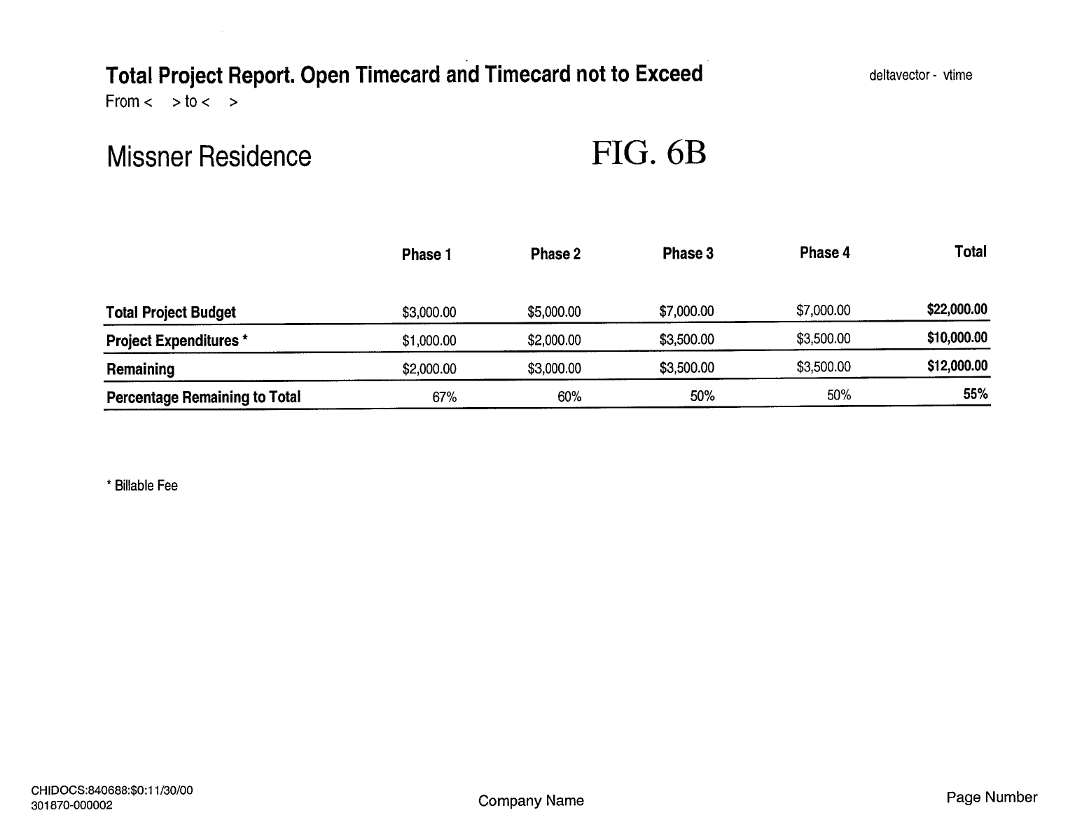

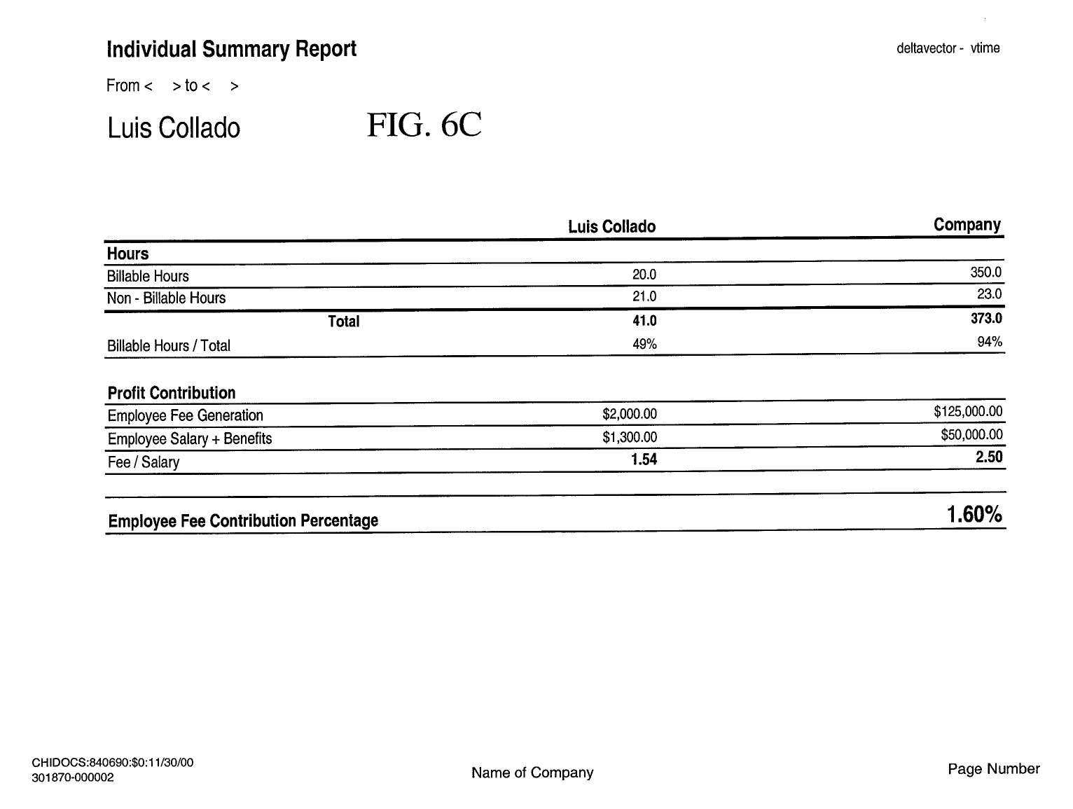

The executive information system 34 further includes a system report generator 42 for generating various reports using the timecard records stored in the system database 38. It should be noted that whereas each calendar system 32 is provided with a user report generator 44 for generating reports for the local user using the locally stored timecard records, the system report generator 42 accesses the system database 38 and thus may generate user reports for any/all users. Moreover, the system report generator 42 generates global reports such as, for example, a project detail report showing the total project budget as well as the number of hours billed to the project by each of the users (FIG. 6A), a project summary report showing the project budget and the total amount billed to the project (FIG. 6B), or an individual summary report for a selected user (FIG. 6C).

FIG. 5C is a block diagram of calendar system 32 which includes a calendar user interface 46 for receiving appointment information necessary to schedule appointments. The appointment information which includes date, start and end time, and an appointment description is stored in a calendar database 48. The calendar user interface 46 enables a user to generate timecard records using the appointment information by associating a given appointment entry with a selected project.

The calendar user interface 46 may pull the project information directly from the system database 38. Alternatively, a local copy of the project information for a given user may be stored in either the calendar database 48 or in a proprietary database 50. In the event that a local copy of the project information is stored, the calendar system will periodically update the local copy by pulling updated project information from the executive information system database 32.

The calendar user interface 46 enables a user to generate a time card record by associating a selected appointment entry with a selected project. Importantly, the calendar user interface 46 only permits the given user to generate timecard records using the displayed projects. The timecard records are stored locally in either the calendar database 48 or the proprietary database 50, and are periodically transferred to the system database 38 by a data transfer module 52. The data transfer module 52 may reside on the calendar system 32 and/or the executive information system 34, and pushes/pulls the timecard records from each calendar database 48 to the system database 38. For example, the calendar system 32 may be configured to update the system database 38 each time a new timecard record is generated.

As described above, the calendar system 32 like software system 12 generally uses three distinct types of data: appointment data, supplemental data, and project data. See, FIG. 2B. The appointment data reflects data conventionally captured by a calendar system 32 including date, appointment start/end time, and description information for each appointment. The project information includes an employee ID, project name and/or a project ID, phase name and/or phase ID, and employee billing rate. Moreover, the project information may further include a billing ID used by the accounting system 22, a maximum expense amount and expense description. The supplemental data includes employee ID, project ID, duration and (optional) expense information.

also shown in FIG. 2B is a representative timecard record, which includes the date, duration and timecard description, the billing amount, and the project ID and/or billing ID. The timecard record may optionally include the expense amount and expense description.

According to a preferred embodiment, a data export module 54 is provided for exporting timecard records from the system database 38 to the accounting system 22. Alternatively, the data export module 54 may be used to export timecard records from the calendar system 32 to the accounting system 22.

According to a preferred embodiment, the administrative interface 40 is part of the executive information system 34, and enables a user to enter project data directly into the system database 38. Alternatively, the administrative interface 40 may be part of the calendar system 32.

According to another aspect of the invention, the administrative interface 40 is a graphical user interface (FIG. 4A) providing drag-and-drop scheduling. In operation, an administrator first defines a number of projects, and then schedules (allocates) a user to a given project by dragging and dropping a user object (graphical representation of the user) onto a project object (graphical representation of the project).

According to another aspect of the invention, the project information may optionally include an hourly rate for each of plural hourly billing categories, wherein the administrative interface 12 prompts an administrator to assign a selected hourly billing category to each user allocated to a given project.

Referring once again to FIG. 5A, a given calendar system 32 may reside on a portable device 56 which is removably connected to the system database 38. According to this implementation, a copy of the project information for the local user must be maintained on the portable device 56 (in the calendar database 48 or the proprietary database 50). In this manner, access to project information is maintained when the portable device 56 is detached and unable to communicate with the system database 38.

In operation, the initial setup of the calendar system 32 identifies whether the system is being installed on a portable device 56 or a desktop device 58. If desired, the local copy of the project information need only be maintained for installations on the portable device 56. If a local copy of project information is maintained, the system 32 periodically updates the project information by copying data from the system database 38 (assuming that the device 56 or 58 is connected to the system database 38).

The software system 32 may optionally be installed on a personal digital assistant (PDA) or like miniature computing device 60 such as, for example, a Palm Pilot®). Due to memory constraints, such installations typically omit either or both of the administrative interface 40 and the user report generator 44. Moreover, due to communications limitations, the PDA 60 is assumed to not communicate directly with the system database 38. Instead, the PDA 60 obtains project information from the portable device 56 or the desktop device 58, and synchronizes the calendar information, project information and timecard records stored on the PDA 60 with the corresponding data stored on the portable device 56 or the desktop device 58. Thereafter, data is transferred from the portable device 56 (or the desktop device 58) to the system database 38 as described above.

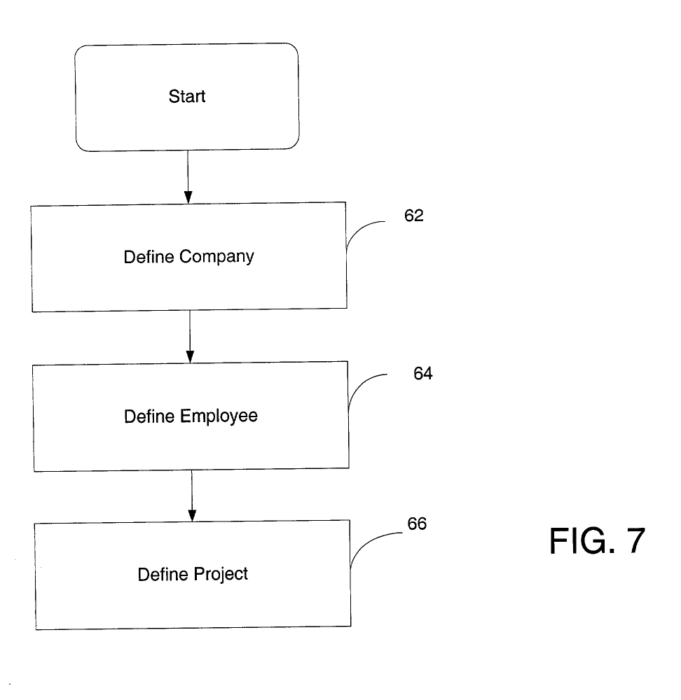

FIG. 7 is a flow diagram showing an overview of the process for defining projects using the administrative interface 40.

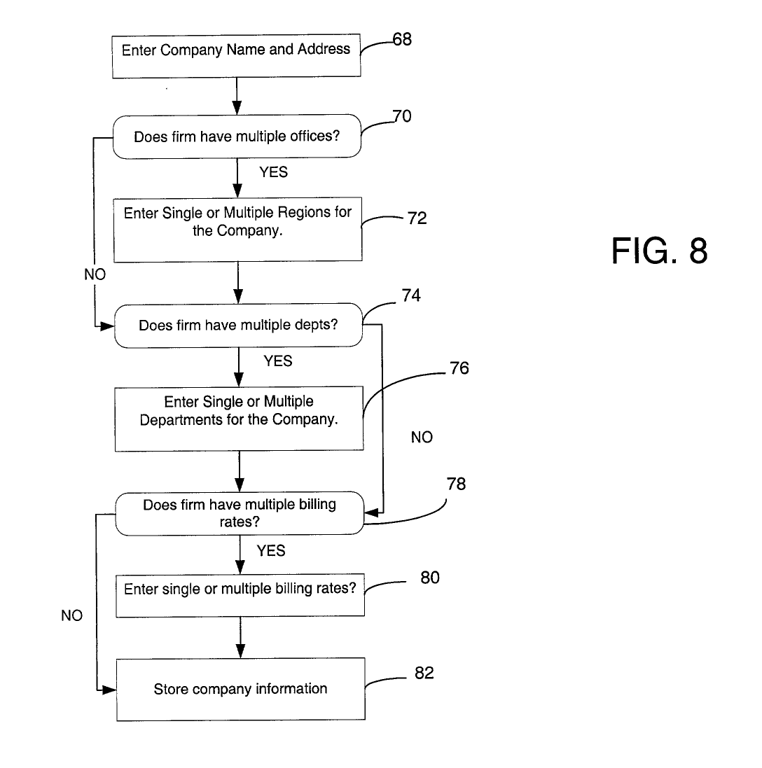

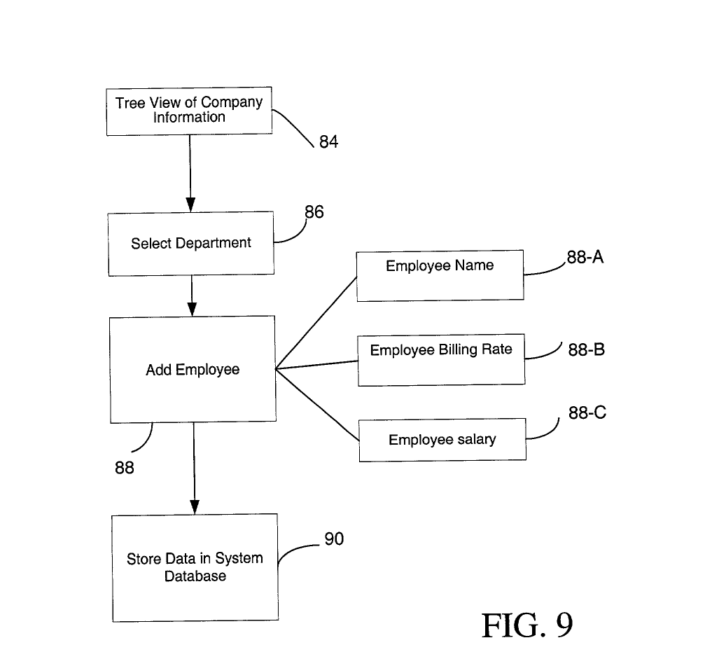

As shown in FIG. 7, there are two preliminary steps before a project is defined. First, the service provider company is defined (step 62). As will be explained in further detail with regard to FIG. 8, step 62 entails defining the structure of the service provider including regional offices and departments within each region. Next, the employees of the service provider company are defined in step 64. As will be explained in further detail with regard to FIG. 9, step 62 entails entering the employee name, billing rate and salary into the system database 38. Thereafter, the project may be defined (step 66).

FIG. 8 is a flowchart showing details of the process for defining the service provider company. The process begins with an optional step of entering the company name and address (step 68). Next, the user is prompted to answer whether there are multiple offices (step 70), and is prompted to enter the name of each office/region (step 72). By manner of illustration, the right hand portion of FIG. 4A depicts a tree view showing multiple regions (Chicago, New York, Detroit) defined for a service provider company.

Subsequently, the user is prompted to answer whether there are multiple departments for each office/region (step 74), and is prompted to enter the name of each department (step 76). By manner of illustration, the right hand portion of FIG. 4A depicts a tree view showing multiple departments (architecture and interiors) defined for the Chicago region.

Next, the user is prompted to answer whether there are multiple billing rates (step 78), and is prompted to enter the billing rate(s) (step 80). Finally, the company information is stored in the system database 38 (step 82). As will be appreciated by one of ordinary skill in the art, the majority of the company information need only be entered during the initial set-up of the executive information system 34.

FIG. 9 is a flowchart showing details of the process for defining the employees of the service provider company. The process begins with a tree view of the company information (step 84) which information was previously defined in FIG. 8. See, e.g. FIG. 4A. The user adds a user to a given department by, for example, selecting the department with a pointing device such as a mouse (step 86), and entering an employee name (step 88-A), billing rate (step 88-B) and salary (step 88-C). Multiple employees may be entered for each department. Finally, the employee information is stored in the system database 38 (step 90).

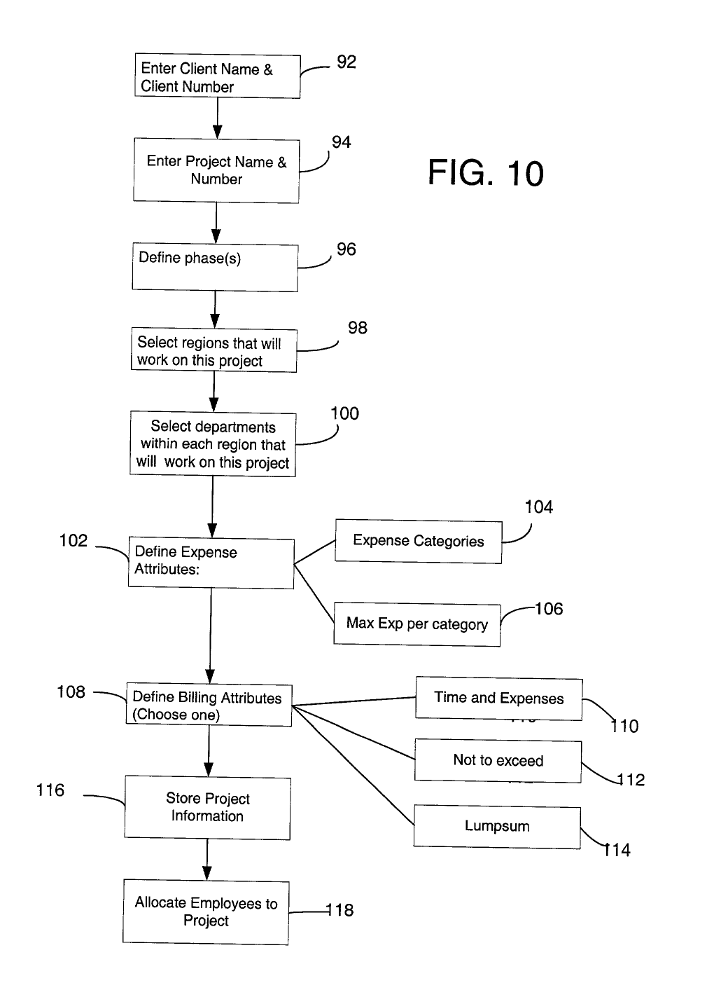

FIG. 10 is a flowchart showing details of the process for defining a project.

The process begins by entering the client name and billing ID (step 92), and the project name and project ID (step 94). Next, the user is prompted to define the phases for the project (step 96), and to select the regions (offices of the service provider) which will work on each phase (step 98). Subsequently, the user is prompted to define the departments within each of the service provider's offices which will work on a given phase (step 100).

According to a preferred embodiment, regions, departments, or employees are assigned to a project from a tree view such as shown in FIG. 4A. In operation, the user selects an object such as a department, and drags and drops the object on the project.

In step 102, the expense attributes for each project are defined. The expense attributes include a list of expense categories 104 such as parking, tolls, taxi, airfare. Optionally, the expense attributes may include a maximum expense 106 for each expense category. In step 108, the billing attributes are selected from a list of attributes including time and expense, not to exceed, and lump sum, and in step 116 the project information is stored in the system database 38. Finally, employees (resources) are allocated to the project (step 118).

The time and expense billing attribute identifies that the client will be billed for actual time and expenses expended during each phase of a project, and does not include a maximum amount of time. Corresponding, the not to exceed attribute identifies that the client will be billed for actual time and expenses up to (not to exceed) a maximum amount. Finally, the lump sum attribute identifies that the client will be billed a lump sum regardless of the actual time and expenses.

While various embodiments of the present invention have been shown and described, it should be understood that other modifications, substitutions and alternatives can be made without departing from the spirit and scope of the invention, which should be determined from the appended claims.

What is claimed is:

1. A software system for an appointment calendar system having a calendar database storing plural appointment entries, each appointment entry containing date, time duration and descriptive appointment information, the software system comprising:
an administrative interface for entering project information for each of a plurality of projects;
a timecard user interface for creating timecard entries by associating a selected calendar appointment entry with a selected one of said plurality of projects; and
a data export module for exporting said timecard entries to a stand-alone accounting system.

2. The software system according to claim 1, wherein said project information is stored in at least one of a proprietary database and the calendar database.

3. The software system according to claim 1, further comprising a user report generator for generating timecard reports on one of a calendar period basis, a phase basis, and a project basis.

4. The software system according to claim 1, wherein said project information includes an hourly rate for each of plural hourly billing categories, and said administrative interface prompts an administrator to assign a selected one of said hourly billing categories to each user allocated to a given project.

5. The software system according to claim 1, wherein said project information includes at least one expense category, said user interface displaying said at least one expense category and receiving expense information only for the displayed expense categories.

6. The software system according to claim 5, wherein said project information includes a maximum expense amount for each said at least one expense category, said user interface alerting said user if said entered expense information exceeds said maximum expense.

7. A software system providing seamless integration between an executive information system and a plurality of calendar systems each storing appointment information in a calendar database, the software system comprising:
a executive information system including:
a executive information system database;
an administrative interface for entering project information for each of a plurality of projects, user information for at least one user, and scheduling said at least one user to each of said plurality of projects, said project information being stored in said executive information system database; and
a system report generator for accessing said executive information system database and generating at least one of user reports for a selected user and global reports for said plurality users on at least one of a calendar basis and a project basis; and
a plurality of calendar systems each storing appointment information in a calendar database, and each including:
a calendar user interface for displaying said appointment information and said project information for a given user, and generating timecard records by associating said project information for a selected project with the appointment information for a selected appointment;
said calendar user interface allowing the given user to generate timecard records using the displayed projects only, and storing said timecard records in the calendar database; and
a user report generator for each calendar system accessing the calendar database and generating reports on a calendar basis and on a project basis;
at least one data transfer module for transferring timecard records from each of said plurality of calendar databases to said executive information system database; and
a data export module for exporting timecard records from said executive information system database to an external accounting system.

8. The software system according to claim 7, wherein said executive information system database is stored on a server and each said calendar database is stored on a separate personal computer which communicates with said server.

9. The software system according to claim 8, wherein selected ones of said plurality of calendar systems further comprise a first project file containing a list of projects to which a given user has been allocated, said first project file being periodically updated with information from said executive information system database such that said calendar user interface may continue to generate timecard records when the communication between the computer and the server is interrupted.

10. The software system according to claim 7, wherein said administrative interface is a graphical user interface providing drag-and-drop scheduling whereby users are allocated to a project by dragging and dropping a user object onto a project object.

11. The software system according to claim 8, wherein said project information includes an hourly rate for each of plural hourly billing categories, and said administrative interface prompts the administrator to assign a selected one of said hourly billing categories to each user allocated to a given project.

12. The software system according to claim 7, wherein said project information includes at least one expense category, said user interface displaying said at least one expense category and receiving expense information only for the displayed expense categories.

13. The software system according to claim 12, wherein said project information includes maximum expense for each said at least one expense category, said user interface alerting said user if said entered expense information exceeds said maximum expense.

14. The software system according to claim 9, further comprising:
a portable calendar system storing appointment information in a portable calendar database, said portable calendar system including:
a second project file containing a list of projects to which a given user has been allocated, said second project file being periodically updated with project information from one of a selected said first project file and said executive information system database;
a portable calendar user interface for displaying said appointment information and said project information for a given user, and generating timecard records by associating said project information for a selected project with the appointment information for a selected appointment; and
said portable calendar user interface allowing the given user to generate timecard records using the displayed projects only, and storing said timecard records in said portable calendar database; and
a data synchronization module for synchronizing said calendar database and said portable calendar database.

15. The software system according to claim 1, wherein the administrative interface displays a warning message if a number of project to which a given user is allocated exceeds a predetermined number.
